(19) United States
(12) Patent Application Publication
(10) Pub. No.: US 2011/0134283 A1
(43) Pub. Date: Jun. 9, 2011

(54) PHOTOGRAPHING APPARATUS AND PHOTOGRAPHING METHOD

(75) Inventor: Isamu Ryu, Yokohama (JP)

(73) Assignee: Samsung Electronics Co., Ltd., Suwon-si (KR)

(21) Appl. No.: 12/963,759

(22) Filed: Dec. 9, 2010

(30) Foreign Application Priority Data
Dec. 9, 2009 (JP) 2009-279843
Nov. 29, 2010 (KR) 10-2010-0119788

(51) Int. Cl. H04N 9/68; H04N 5/228

(52) U.S. Cl. 348/234; 348/222.1; 348/E09.053; 348/E05.031

(57) ABSTRACT

A photographing apparatus and a photographing method for definitely and easily specifying a marine snow reflected when emitting strobe light in underwater photographing. The photographing apparatus includes: an image obtaining unit which obtains a strobe non-emission image and a strobe emission image, wherein the strobe non-emission image is obtained by capturing a subject without emitting strobe light in photographing, and the strobe emission image is obtained by capturing the subject by emitting the strobe light; an edge detector which detects an edge of the strobe non-emission image and an edge of the strobe emission image; a differential calculator which calculates a differential between the strobe non-emission image and the strobe emission image from which the edges have been detected, to generate a differential image; and a marine snow detector which detects a combined part of a dot-shaped edge of the strobe non-emission image and a looped curve-shaped edge of the strobe emission image in the differential image, as a marine snow occurring part.

### CROSS-REFERENCE TO RELATED PATENT APPLICATION

This application claims the benefit of Japanese Patent Application No. 2009-279843, filed on Dec. 9, 2009, in the Japanese Patent Office, and Korean Patent Application No. 10-2010-0119788, filed on Nov. 29, 2010, in the Korean Intellectual Property Office, the disclosures of which are incorporated herein in their entirety by reference.

### BACKGROUND

1. Field of the Invention

The invention relates to a photographing apparatus and a photographing method.

2. Description of the Related Art

If a stroboscope is used to capture a still image in the water using a photographing apparatus, such as a digital still camera or the like, a fine object such as sand, plankton, or the like existing in the water reflects the strobe light. Therefore, the strobe light reflected from the fine object is formed and reflected as a white circle or polygon in the still image. The white circle or polygon reflected in the still image is larger than the actual size of the fine object, which is referred to as a marine snow phenomenon.

Japanese Patent Publication No. 2003-140239 and Japanese Patent Publication No. 2003-202618 each disclose a technique for controlling light emissions of internal and external stroboscopes, i.e., a technique for controlling light leakage of the internal stroboscope and the light emission of the external stroboscope. These references disclose that for underwater photographing, an additional filter should be installed in an internal stroboscope of a photographing apparatus or light emitted from an external stroboscope should be controlled, thereby requiring a long time until actual photographing is performed.

Japanese Patent Publication No. 2008-219367 and Japanese Patent Publication No. 2008-227569 each disclose a technique for comparing a strobe non-emission image and a strobe emission image to extract an area including an object to be captured in stroboscopic photographing. However, in these references, underwater photographing or a marine snow occurring in underwater photographing is not considered, and thus a marine snow occurring part cannot be specified in a captured image.

Japanese Patent Publication No. 2007-189542 discloses a technique by which when marine snow is reflected, a white dot part of a strobe emission image is detected based on the size of an area, and an image of an area corresponding to the white dot part is extracted from a strobe non-emission image to combine the image with a strobe image. In this reference, a white dot part is detected from a strobe emission image to calculate a total amount of the white dot part. An object which is not related to marine snow may also be detected as marine snow. As a result, an object which does not need to be recovered becomes an object to be recovered, and thus unnecessarily increasing the recovery operation. Also, a strobe image is recovered using a strobe non-emission image. However, since chroma of the strobe non-emission image is poor, and thus the strobe non-emission image is unclear, the white dot part of a strobe emission image may not be precisely recovered.

The following papers disclose techniques for recovering a part of an image which has lost data:

“Fractal-based Image Disocclusion”, Izoe Sintaro et al., Symposium Data of 6^{th} Image Media Processing Symposium, Image Engineering Research Committee of Institute of Electronics, Information and Communication Engineers, Nov. 14, 2001, p. 39-40.

“Fractal-based Image Disocclusion using Kernel Principal Components Analysis”, Izoe Sintaro et al., Technical Report of Institute of Electronics, Information and Communication Engineers Vol. 101 No. 362 PRMU2001-106, Institute of Electronics, Information and Communication Engineers, Oct. 11, 2001, p. 55-62.

“Image Interpolation Using BPLP with an Eigenspace Referencing Method”, Amano Toshiuki and Iguchi Seizi, Lecture Dissertation Collection of Image Recognition and Understanding Symposium vol. 1, Pattern Recognition and Media Understanding Research Society of Institute of Electronics, Information and Communication Engineers, 2000, p. 217-222.

These papers are directed to recovery processing techniques. A user checks a recovery part with their naked eyes and manually designates recovery areas one-by-one by to specify the recovery part. Therefore, if a large number of marine snows occur in an image, a large number of processes are performed to designate recovery areas.

### SUMMARY

As described above, there is no technique for precisely and easily extracting marine snow occurring in an image.

Accordingly, an embodiment of the invention provides a photographing apparatus for precisely and easily specifying marine snow reflected when strobe light is emitted in underwater photographing, and a photographing method.

According to an embodiment of the invention, there is provided a photographing apparatus including: an image obtaining unit which obtains a strobe non-emission image and a strobe emission image, wherein the strobe non-emission image is obtained by capturing a subject without emitting strobe light in photographing, and the strobe emission image is obtained by capturing the subject by emitting the strobe light; an edge detector which detects an edge of the strobe non-emission image and an edge of the strobe emission image; a differential calculator which calculates a differential between the strobe non-emission image and the strobe emission image from which the edges have been detected, to generate a differential image; and a marine snow detector which detects a combined part of a dot-shaped edge of the strobe non-emission image and a looped curve-shaped edge of the strobe emission image in the differential image, as a marine snow occurring part.

According to this embodiment, a strobe non-emission image and a strobe emission image may be obtained, and edges of the strobe non-emission image and the strobe emission image may be detected. A differential between the strobe non-emission image and the strobe emission image, the edges of which have been detected, may be calculated to generate a differential image. A part which a dot-shaped edge of the strobe non-emission image and a looped curve-shaped edge of the strobe emission image enclosing the dot-shaped edge are combined may be detected as a marine snow.

The photographing apparatus may further include a recovery area making unit which makes position information and area information regarding the marine snow occurring part and an area enclosing the marine snow occurring part to recover the marine snow occurring part. The photographing apparatus may further include a storage unit which stores the area information and position information. According to this structure, a marine snow occurring part may be recovered based on position information and area information of the marine snow occurring part and an area enclosing the marine snow occurring part.

The photographing apparatus may further include a luminance corrector which corrects a luminance value of the strobe non-emission image based on a light amount of the strobe light emitted when the subject is captured by emitting the strobe light, wherein the edge detector detects an edge of the strobe non-emission image based on the strobe non-emission image, the luminance value of which has been corrected. According to this structure, a luminance value of a strobe non-emission image may be corrected based on a light amount of strobe light in strobe emission photographing, and an edge of the strobe non-emission image, the luminance value of which has been corrected may be detected.

The photographing apparatus may further include a matching unit which matches positions of the strobe non-emission image and the strobe emission image, the edges of which have been detected, wherein the differential calculator calculates a differential between the strobe non-emission image and the strobe emission image, the positions of which have been matched. According to this structure, positions of a strobe non-emission image and a strobe emission image, edges of which have been detected may be matched to calculate a differential between the strobe non-emission image and the strobe emission image.

The matching unit may vary a correction compensation range of the position match based on a shutter speed when the subject is captured without emitting the strobe light. The correction range of the position match may depend on the shutter speed in strobe non-emission photographing.

According to another embodiment of the invention, there is provided a photographing method including: obtaining a strobe non-emission image and a strobe emission image, wherein the strobe non-emission image is obtained by capturing a subject without emitting strobe light in photographing, and the strobe emission image is obtained by capturing the subject by emitting the strobe light; detecting edges of the strobe non-emission image and the strobe emission image; calculating a differential between the strobe non-emission image and the strobe emission image, the edges of which have been detected, to generate a differential image; and detecting a combined part of a dot-shaped edge of the strobe non-emission image and a looped curve-shaped edge of the strobe emission image in the differential image, as a marine snow occurring part.

As described above, according to embodiments of the invention, marine snow which is reflected when emitting strobe light may be definitely and easily specified in underwater photographing.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram illustrating a photographing apparatus according to an embodiment of the invention;

FIG. 2 is a flowchart illustrating a photographing operation of the photographing apparatus of FIG. 1, according to an embodiment of the invention;

FIG. 3 is a flowchart illustrating a photographing operation and a marine snow specifying operation of the photographing apparatus of FIG. 1, according to an embodiment of the invention;

FIG. 4 is a flowchart illustrating an operation of detecting a marine snow occurring part of the photographing apparatus of FIG. 1, according to an embodiment of the invention;

FIG. 5 illustrates an image obtained by strobe non-emission photographing, according to an embodiment of the invention;

FIG. 6 illustrates an image obtained by strobe emission photographing, according to an embodiment of the invention;

FIG. 7 illustrates a non-emission edge image based on a strobe non-emission image, according to an embodiment of the invention;

FIG. 8 illustrates an emission edge image based on a strobe emission image, according to an embodiment of the invention;

FIG. 9 illustrates a differential image indicating a differential between a non-emission edge image and an emission edge image, according to an embodiment of the invention;

FIG. 10 illustrates an operation of making a recovery area in a strobe emission image, according to an embodiment of the invention; and

FIG. 11 illustrates a shape of a recovery area.

### DETAILED DESCRIPTION

Embodiments of the invention will now be described more fully with reference to the accompanying drawings. Like reference numerals in the drawings denote like elements, and thus their description will be omitted.

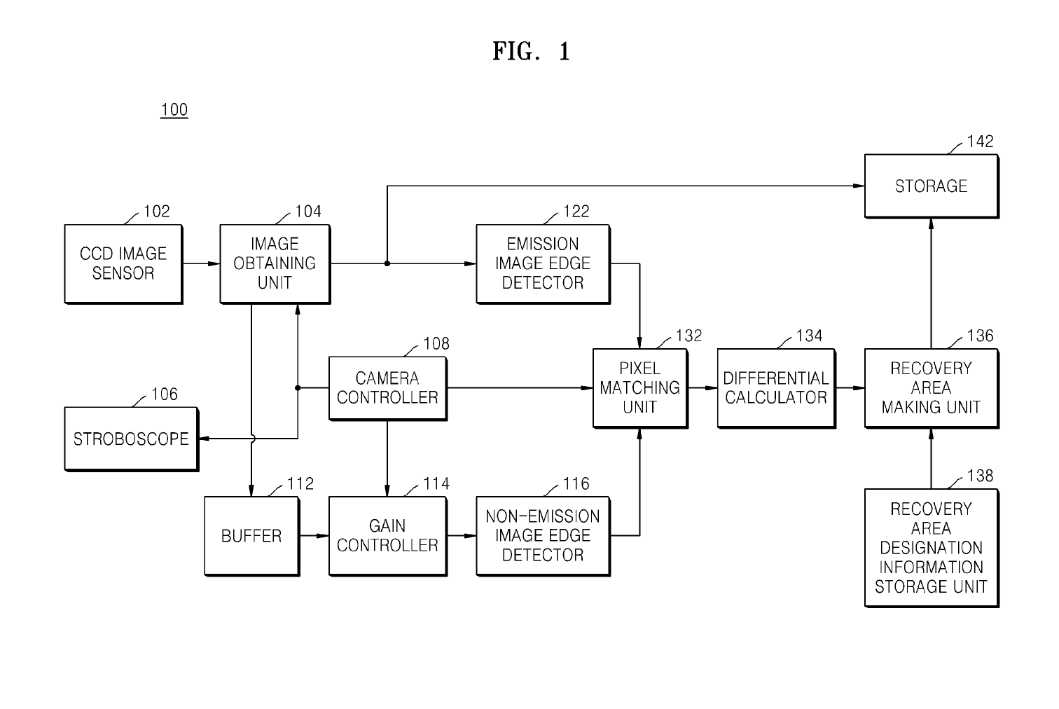

A structure of a photographing apparatus according to an embodiment of the invention will now be described with reference to FIG. 1. FIG. 1 is a block diagram illustrating a photographing apparatus 100 according to an embodiment of the invention.

Referring to FIG. 1, the photographing apparatus 100 may be a digital still camera. The photographing apparatus 100 detects marine snow formed in an image obtained by underwater photographing. The marine snow refers to a phenomenon in which when a still image is captured using a stroboscope in the water, a fine object, such as sand, plankton, or the like, in the water reflects the strobe light, and the strobe light reflected from the fine object is formed and reflected as a white circle or polygon in the still image.

The photographing apparatus 100 includes a charge-coupled device (CCD) image sensor 102, an image obtaining unit 104, a stroboscope 106, a camera controller 108, a buffer 112, a gain controller 114, a non-emission image edge detector 116, an emission image edge detector 122, a pixel matching unit 132, a differential calculator 134, a recovery area making unit 136, a recovery area designation information storage unit 138, and a storage 142.

The CCD image sensor 102 is a photoelectric conversion device that receives light from a subject and converts the light into an electrical signal. Therefore, the CCD image sensor 102 generates an electrical signal according to light. Alternatively, an imaging device, such as a complementary metal oxide semiconductor (CMOS) sensor or the like, may be used instead of the CCD image sensor 102.

The image obtaining unit 104 receives the electrical signal from the CCD image sensor 102, removes noise from the electrical signal, amplifies the electrical signal, and performs an analog-to-digital conversion with respect to the amplified electrical signal to generate an image signal. The image obtaining unit 104 outputs the image signal to the buffer 112 or the emission image edge detector 122.

The stroboscope 106 radiates light onto the subject during photographing based on a light emission amount calculated according to exposure conditions. In the present embodiment, in one-time photographing, strobe non-emission photographing without emitting light through the stroboscope 106 and strobe emission photographing by emitting light through the stroboscope 106 are performed. Therefore, the stroboscope 106 does not emit light in the strobe non-emission photographing.

The camera controller 108 operates as an operation processing apparatus and controlling apparatus through a program and thus controls elements of the photographing apparatus 100. For example, the camera controller 108 controls an image-obtaining time or a strobe light-emission time and calculates a light emission amount of the stroboscope 106.

The buffer 112 stores image data. The buffer 112 temporarily stores image data of the strobe non-emission image which is obtained in the strobe non-emission photographing.

The gain controller 114 corrects a luminance value of the image data of the strobe non-emission image. Since the strobe non-emission image has an insufficient light amount, the luminance value of the image data of the strobe non-emission image is corrected so as to approach a luminance value of image data of the strobe emission image which is obtained in strobe emission photographing. Thereby, the non-emission image edge detector 116 easily detects an edge of the strobe non-emission image. A correction amount of the luminance value of the strobe non-emission image is determined according to an amount of light that is irradiated by the stroboscope 106 in the strobe emission photographing. Thus, the gain controller 114 obtains the amount of light, which is irradiated in the strobe emission photographing, from the camera controller 108. If the light amount of the stroboscope 106 is large, the correction amount is relatively increased. If the light amount of the stroboscope 106 is small, the correction amount is relatively decreased.

The non-emission image edge detector 116 detects an edge of the image data of the strobe non-emission image which has been corrected by the gain controller 114. The detection of the edge may be performed using a general technique and thus will not be described in the present specification. The marine snow is generated through the reflection of the strobe light from a fine object, such as sand, plankton, or the like, in the water. Therefore, a fine object exists in a part of the strobe non-emission image corresponding to a part of the strobe emission image in which a white circular or polygonal marine snow occurs. The non-emission image edge detector 116 performs edge detection processing to detect a dot-shaped edge from the part of the strobe non-emission image in which the marine snow occurs.

The emission image edge detector 122 detects an edge of the image data of the strobe emission image which is obtained by the image obtaining unit 104. Marine snow is reflected as a white circle or polygon in the strobe emission image. Therefore, if the marine snow occurs in the strobe emission image, the emission image edge detector 122 performs edge detection processing to detect a looped curve shape edge, such a circle, a polygon, or the like, from a part of the strobe emission image in which the marine snow occurs.

The pixel matching unit 132 obtains a non-emission edge image which is generated by detecting the edge through the non-emission image edge detector 116 and an emission edge image which is generated by detecting the edge through the emission image edge detector 122. The pixel matching unit 132 matches a position of an edge contour of the non-emission edge image and a position of an edge contour of the emission edge image in each pixel. There is a time lag between photographing timings of the strobe non-emission photographing and the strobe emission photographing in the one-time photographing of the present embodiment. Therefore, in general, the position of the subject may be mis-positioned between the strobe non-emission image and the strobe emission image, and the mis-positioning is corrected through the position match of the pixel matching unit 132.

If the strobe emission photographing is performed after the strobe non-emission photographing, a correction compensation range of the position match is determined according to the shutter speed in the strobe non-emission photographing. Therefore, the pixel matching unit 132 obtains the shutter speed in the strobe non-emission photographing from the camera controller 108. If the shutter speed is slow, the time lag to the strobe emission image becomes longer, and thus the correction compensation range is relatively increased. If the shutter speed is fast, the correction compensation range is relatively decreased.

The differential calculator 134 calculates a differential between the non-emission edge image and the emission edge image, positions of which have been matched. The strobe non-emission photographing and the strobe emission photographing are performed through one-time photographing, and the strobe emission photographing is performed without a time interval longer than or equal to a shutter interval in the strobe non-emission photographing, from the strobe non-emission photographing. Therefore, the difference between a subject image of the strobe non-emission image and a subject image of the strobe emission image after the position match hardly occurs. Thus, if the differential is calculated, image data does not remain in a differential image.

If marine snow occurs in the strobe emission image by performing the strobe photographing underwater, the difference between the subject image of the strobe non-emission image and the subject image of the strobe emission image occurs in a part of the strobe emission image in which the marine snow occurs. The differential image includes the dot-shaped edge of the non-emission edge image and the looped curve-shaped edge of the emission edge image in the marine snow occurring part. Therefore, the differential calculator 134 detects a part which becomes the dot-shaped edge in the strobe non-emission photographing and the looped curve-shaped edge in the strobe emission photographing. The differential calculator 134 is an example of a marine snow detector.

The recovery area making unit 136 obtains recovery area designation information from the recovery area designation storage unit 138. The recovery area making unit 136 determines information regarding a recovery area for recovering the marine snow occurring part based on position information of the marine snow occurring part detected by the differential calculator 134. The recovery area making unit 136 transmits the position information of the marine snow occurring part and the information regarding the recovery area for recovering the marine snow occurring part to the storage 142.

In the present embodiment, an unrecovered part may be recovered as in the techniques described in the above-described papers, “Fractal-based Image Disocclusion”, “Fractal-based Image Disocclusion using Kernel Principal Components Analysis”, and “Image Interpolation Using BPLP with an Eigenspace Referencing Method”. In other words, the marine snow occurring part of the strobe emission image is recovered using image data of the strobe emission image and not using image data of another image such as the strobe non-emission image. Therefore, if the image data of the strobe non-emission image is used, chroma of the strobe non-emission image is poor, and the strobe non-emission image is unclear. Thus, a problem of not precisely recovering a white dot part of the strobe emission image may be solved. Image data of a range, which is wider than the marine snow occurring part and encloses the marine snow occurring part, is used to recover the marine snow occurring part of the strobe emission image using the image data of the strobe emission image.

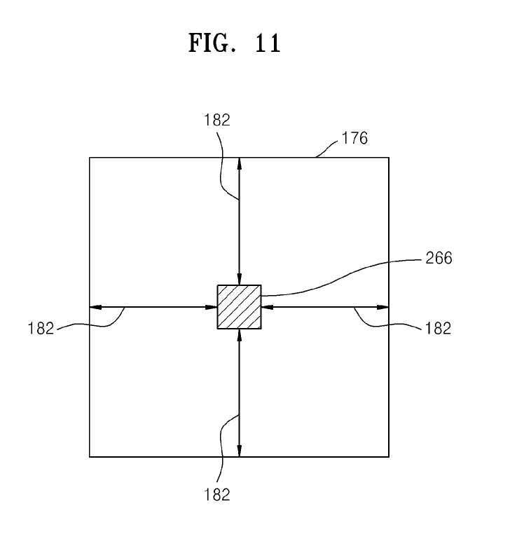

The recovery area designation information storage unit 138 stores recovery area designation information. The recovery area designation information is read by the recovery area making unit 136. The recovery area designation information is distance information 182 for designating a detected recovery area 176 of a marine snow occurring part 266 as shown in FIG. 11. FIG. 11 is a view illustrating a shape of a recovery area, according to an embodiment of the invention. FIG. 11 illustrates a case where a marine snow occurring part has a square shape, but the invention is not limited thereto. Even if the marine snow occurring part is a polygon and not a circle or square, a recovery area may be designated using recovery area designation information, such as distance information or the like.

The storage 142 stores area information and position information of the designated recovery area, along with the strobe emission image. The area information and position information of the recovery area is used for recovery processing performed in a non-photographing state of the photographing apparatus 100 or recovery processing performed by an external information processing apparatus, such as a personal computer (PC) or the like. Recovery processing may be performed to remove the marine snow occurring part reflected as a white circle or polygon in the strobe emission image so as to recover the subject image in which a marine snow does not occur.

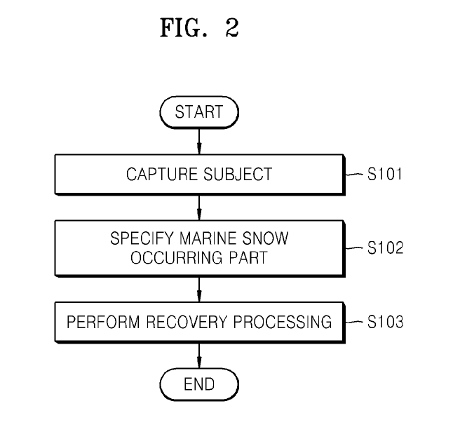

A photographing operation of the photographing apparatus 100 according to an embodiment of the invention will now be described with reference to FIG. 2. FIG. 2 is a flowchart illustrating the photographing operation of the photographing apparatus 100 of FIG. 1, according to an embodiment of the invention.

In steps S101, a subject is captured in the water by a user. If the subject is captured using a stroboscope, marine snow may occur in a strobe emission image. Therefore, in step S102, the photographing apparatus 100 specifies a marine snow occurring part. The marine snow occurring part is stored in the photographing apparatus 100. In step S103, recovery processing is performed in a non-photographing state of the photographing apparatus 100 or by an external information processing apparatus, such as a PC or the like, using the stored marine snow occurring part.

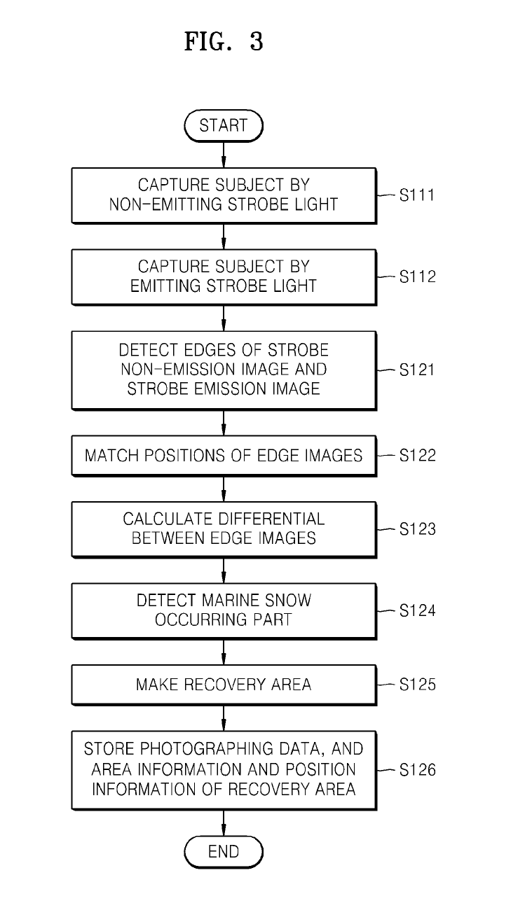

A photographing operation and a marine snow specifying operation of the photographing apparatus 100 according to an embodiment of the invention will now be described. FIG. 3 is a flowchart illustrating the photographing operation and the marine snow specifying operation of the photographing apparatus 100 of FIG. 1, according to an embodiment of the invention.

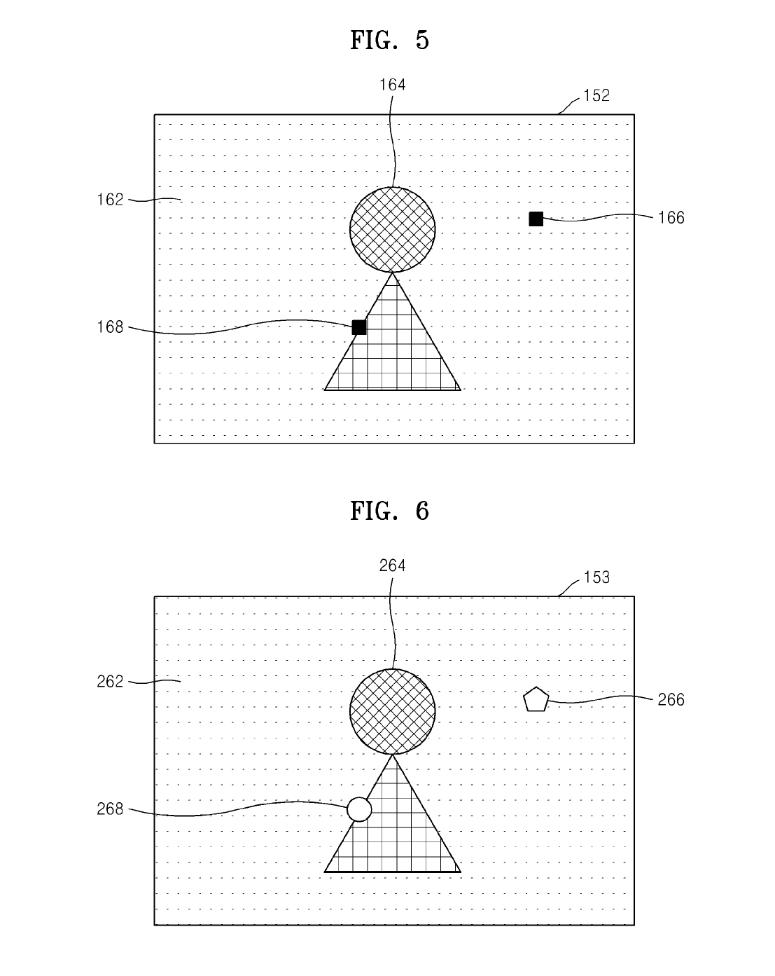

The operation that one-time photographing is started by a user and strobe light is emitted under exposure conditions will be described. In step S111, pre-photographing (strobe non-emission photographing), in which strobe light is not emitted, is performed before main photographing is performed by emitting strobe light, and image data of a strobe non-emission image is temporarily stored in the buffer 112. FIG. 5 illustrates an image obtained by strobe non-emission photographing, according to an embodiment of the invention. Marine snow does not occur in an image 152, and a person 164 as a subject in the water 162 or fine objects 166 and 168 as factors of the marine snow is reflected in the image 152. Here, the strobe non-emission image has a resolution sufficient to detect an edge of a fine object through an edge detection of a following operation end and thus does not need to have a resolution which is high like a strobe emission image.

In step S112, after the strobe non-emission photographing, the main photographing (strobe emission photographing) emitting the strobe light is performed. FIG. 6 illustrates an image obtained by strobe emission photographing, according to an embodiment of the invention. A person 624 as a subject in the water 262 and marine snows 266 and 268 are reflected in an image 153. The above-described steps correspond to the photographing operation of the photographing apparatus 100. The marine snow specifying operation will now be described based on a strobe non-emission image and a strobe emission image.

Since the strobe non-emission image is darker than the strobe emission image, the gain controller 114 corrects a luminance value of image data of the strobe non-emission image so that the luminance value approaches a luminance value of the strobe emission image. The correction amount of the luminance value is increased or decreased according to a light amount of the stroboscope 106 in the strobe emission photographing. Therefore, it becomes easier to detect an edge of the image data of the strobe non-emission image at the following operation.

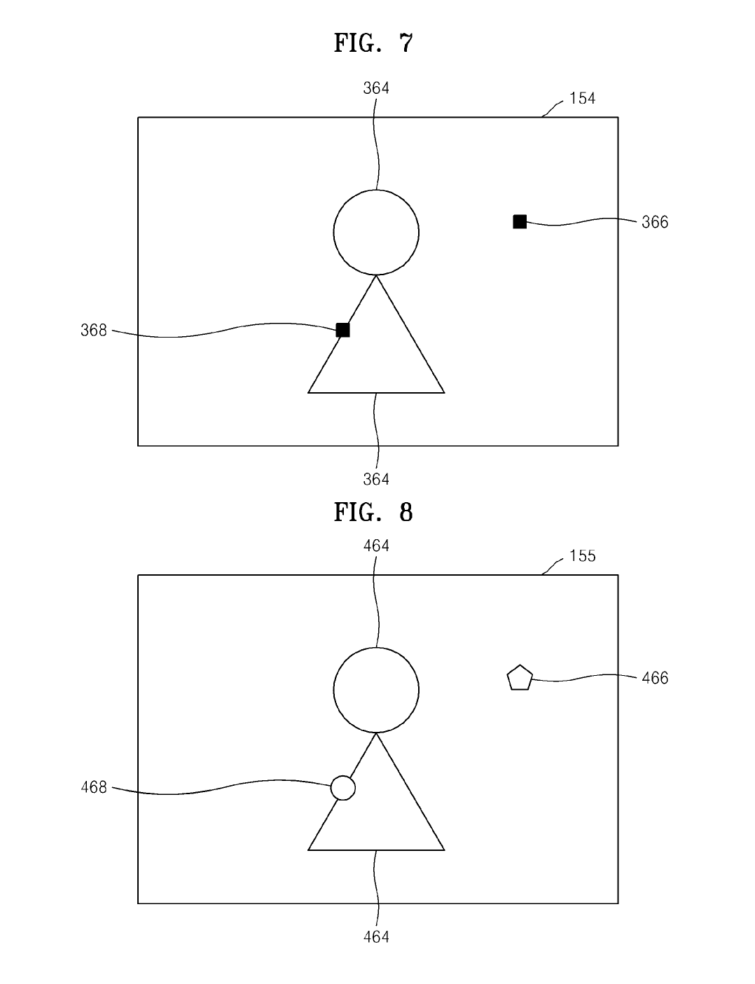

In step S121, the non-emission image edge detector 116 detects an edge of the image data of the strobe non-emission image, and the emission image edge detector 122 detects an edge of the image data of the strobe emission image. As a result, characteristic amounts of the strobe non-emission image and the strobe emission image may be obtained. FIG. 7 illustrates a non-emission edge image based on a strobe non-emission image, according to an embodiment of the invention. A contour 364 of a person or contours 366 and 368 of fine objects is detected in a non-emission edge image 154. FIG. 8 illustrates an emission edge image based on a strobe emission image, according to an embodiment of the invention. A contour 464 of a person or contours 466 or 468 of a marine snow is detected in an emission edge image 155. Here, edge information of a strobe emission image may be edge information obtained in development processing in the photographing apparatus 100 or edge information obtained from an additionally installed edge detector.

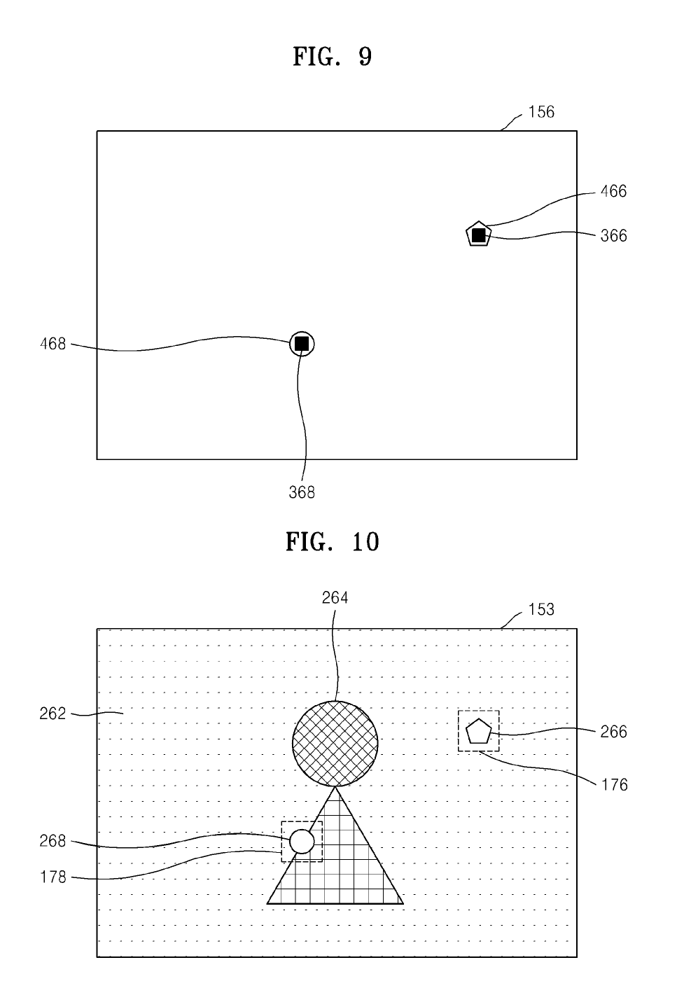

In step S122, positions of the non-emission edge image and the emission edge image are matched. The position match varies a correction compensation range according to the shutter speed in strobe non-emission photographing. In step S123, a differential between the non-emission edge image and the emission edge image, positions of which have been matched, is calculated. FIG. 9 illustrates a differential image indicating a differential between a non-emission edge image and an emission edge image, according to an embodiment of the invention. After positions of the non-emission edge image and the emission edge image are matched, the contours 364 and 464 of the persons of FIGS. 7 and 8 are offset and thus do not appear in an edge image 156, and only contours 366 and 368 of fine objects and contours 466 and 468 of marine snows appear in the edge image 156.

In step S124, a part which becomes a dot-shaped edge in strobe non-emission photographing and a looped curve-shaped edge, such as a circle or polygon, in strobe emission photographing is detected as a marine snow occurring part.

If recovery processing is performed using the techniques of the papers, “Fractal-based Image Disocclusion”, “Fractal-based Image Disocclusion using Kernel Principal Components Analysis”, and “Image Interpolation Using BPLP with an Eigenspace Referencing Method”, a marine snow occurring part is required to be enclosed by an area which is wider than an unrecovered part in order to recover the unrecovered part. In step S125, a recovery area including marine snow occurring parts is made according to preset recovery area designation information. FIG. 10 illustrates an operation of making a recovery area in a strobe emission image, according to an embodiment of the invention. Recovery areas 176 and 178 are designated so as to enclose marine snows 266 and 268 through making of the recovery area.

In step S126, position information or area information of the recovery area is stored in the storage 142, along with photographing data of the strobe emission image. The above-described operation corresponds to the marine snow specifying operation of the photographing apparatus 100. The area information and position information of the recovery area stored in the storage 142 may be used for recovery processing which is performed in a non-photographing state of the photographing apparatus 100 or by an external information processing apparatus, such as a PC or the like.

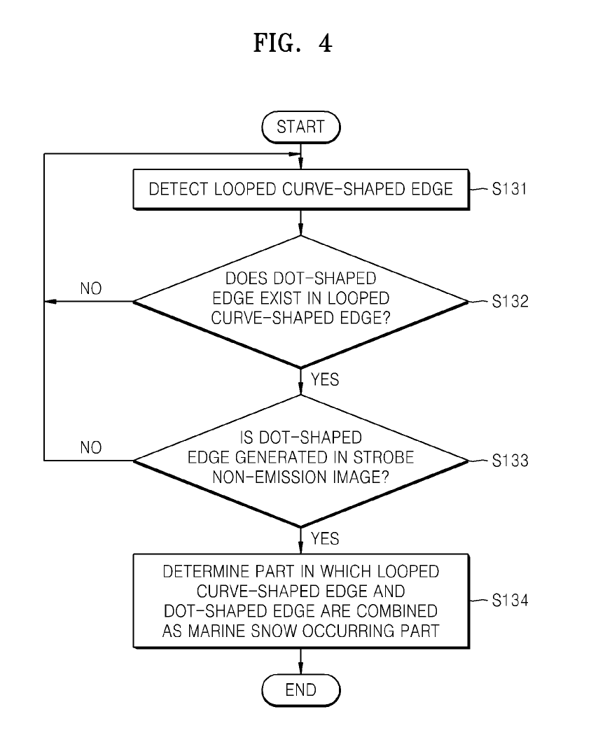

An operation of detecting a marine snow occurring part in step S124 will now be described with reference to FIG. 4. FIG. 4 is a flowchart illustrating an operation of detecting a marine snow occurring part, according to an embodiment of the invention.

In step S131, a looped curve-shaped edge is detected in a differential image. In step S132, a determination is made as to whether a dot-shaped edge exists in the detected looped curve-shaped edge. If it is determined that the dot-shaped edge exists in the detected looped curve-shaped edge, a determination is made as to whether the dot-shaped edge is generated in a strobe non-emission image, in operation S133. If the dot-shaped edge existing in the looped curve-shaped edge agrees with a fine object of the strobe non-emission image, a part into which the looped curve-shaped edge and the dot-shaped edge are combined is determined as a marine snow occurring part in step S134.

If the dot-shaped edge does not exist in the looped curve-shaped edge in the differential image, or the dot-shaped edge in the looped curve-shaped edge is not from the strobe non-emission image, it is determined that the part is not the marine snow occurring part, and then a next looped curve-shaped edge is detected.

As described above, a marine snow is reflected as a white circle or polygon in an image due to a reflection of strobe light from a fine object. Therefore, a part which becomes a dot-shaped edge in an edge image of a strobe non-emission image and a looped curve-shaped edge in an edge image of a strobe emission image is detected as the marine snow. A determination is made as to whether the dot-shaped edge of the strobe non-emission image exists in the looped curve-shaped edge, using a differential image in order to definitely specify a marine snow occurring part. Also, a recovery area does not need to be designated with the naked eyes of a user. The marine snow occurring part is specified, and area information and position information of the marine snow occurring part is stored to efficiently remove marine snow from an image captured in the water so as to recover the image to an image which does not have marine snow.

A conventional technique for detecting a white dot part of a strobe emission image based on a size of an area, to specify a marine snow occurring part is described in Japanese Patent Publication No. 2007-189542. However, in this conventional technique, a subject, which is not related to a marine snow, is also detected as a marine snow occurring part. As a result, an object which does not need to be recovered becomes an object to be recovered, and thus a recovery part increases. According to the present embodiment, a subject, which is not related to a marine snow, is not detected as a marine snow, and a marine snow occurring part is definitely specified. Therefore, according to the operation of specifying the marine snow according to the present embodiment, a recovery area does not increase.

In Japanese Patent Publication No. 2007-189542, a strobe image is recovered using a strobe non-emission image. Since chroma of the strobe non-emission image is poor, and thus the strobe non-emission image is unclear, a white dot part of a strobe emission image is not precisely recovered. In the present embodiment, a marine snow occurring part of a strobe emission image is recovered using image data of the strobe emission image and not using image data of another image, such as a strobe non-emission image or the like. Also, an area enclosing the marine snow occurring part is designated as a recovery area. Accordingly, recovery processing is performed using area information and position information of the recovery area obtained by a marine snow specifying operation of the present embodiment to obtain a highly reappearing image which does not have a marine snow.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A photographing apparatus comprising:
an image obtaining unit which obtains a strobe non-emission image and a strobe emission image, wherein the strobe non-emission image is obtained by capturing a subject without emitting strobe light, and the strobe emission image is obtained by capturing the subject by emitting the strobe light;
an edge detector which detects an edge of the strobe non-emission image and an edge of the strobe emission image;
a differential calculator which calculates a differential between the strobe non-emission image and the strobe emission image from which the edges have been detected, to generate a differential image; and
a marine snow detector which detects a combined part of a dot-shaped edge of the strobe non-emission image and a looped curve-shaped edge of the strobe emission image in the differential image, as a marine snow occurring part.

2. The photographing apparatus of claim 1, further comprising a recovery area making unit which determines position information and area information regarding the marine snow occurring part and an area enclosing the marine snow occurring part to recover the marine snow occurring part.

3. The photographing apparatus of claim 2, further comprising a storage unit which stores the area information and position information.

4. The photographing apparatus of claim 1, further comprising a luminance corrector which corrects a luminance value of the strobe non-emission image based on a light amount of the strobe light emitted when the subject is captured by emitting the strobe light,
wherein the edge detector detects an edge of the strobe non-emission image based on the strobe non-emission image, the luminance value of which has been corrected.

5. The photographing apparatus of claim 2, further comprising a luminance corrector which corrects a luminance value of the strobe non-emission image based on a light amount of the strobe light emitted when the subject is captured by emitting the strobe light,
wherein the edge detector detects an edge of the strobe non-emission image based on the strobe non-emission image, the luminance value of which has been corrected.

6. The photographing apparatus of claim 3, further comprising a luminance corrector which corrects a luminance value of the strobe non-emission image based on a light amount of the strobe light emitted when the subject is captured by emitting the strobe light,
wherein the edge detector detects an edge of the strobe non-emission image based on the strobe non-emission image, the luminance value of which has been corrected.

7. The photographing apparatus of claim 1, further comprising a matching unit which matches positions of the strobe non-emission image and the strobe emission image, the edges of which have been detected,
wherein the differential calculator calculates a differential between the strobe non-emission image and the strobe emission image, the positions of which have been matched.

8. The photographing apparatus of claim 7, wherein the matching unit varies a correction range of the position match based on a shutter speed when the subject is captured without emitting the strobe light.

9. A photographing method comprising the steps of:
obtaining a strobe non-emission image and a strobe emission image, wherein the strobe non-emission image is obtained by capturing a subject without emitting strobe light, and the strobe emission image is obtained by capturing the subject by emitting the strobe light;
detecting edges of the strobe non-emission image and the strobe emission image;
calculating a differential between the strobe non-emission image and the strobe emission image, the edges of which have been detected, to generate a differential image; and
detecting a combined part of a dot-shaped edge of the strobe non-emission image and a looped curve-shaped edge of the strobe emission image in the differential image, as a marine snow occurring part.
